(19) United States
(12) Patent Application Publication
(10) Pub. No.: US 2016/0019092 A1
(43) Pub. Date: Jan. 21, 2016

(54) METHOD AND APPARATUS FOR CLOSING PROGRAM, AND STORAGE MEDIUM

(71) Applicant: Tencent Technology (Shenzhen) Company Limited, Shenzhen (CN)

(72) Inventors: Cancai YUAN, Shenzhen (CN); Yingru DENG, Shenzhen (CN); Junwei LIU, Shenzhen (CN); Xinxin ZHANG, Shenzhen (CN); Lei LONG, Shenzhen (CN)

(73) Assignee: Tencent Technology (Shenzhen) Company Limited

(21) Appl. No.: 14/803,891

(22) Filed: Jul. 20, 2015

Related U.S. Application Data
(63) Continuation of application No. PCT/CN2013/086880, filed on Nov. 11, 2013.

(30) Foreign Application Priority Data
Jan. 30, 2013 (CN) 201310035963.0

(51) Int. Cl. G06F 9/48; G06F 3/0484

(52) U.S. Cl. CPC G06F 9/4881; G06F 3/04842; G06F 3/04847

(57) ABSTRACT

A method and an apparatus for closing a program, and a storage medium are provided. The method includes: opening, by a mobile terminal, a task management area of a multitasking processing queue, where a response area is provided in the task management area; detecting, by the mobile terminal, in the response area; and closing, by the mobile terminal, all programs in the multitasking processing queue in response to a specified operation of a user detected in the response area. An operation of closing a background program is simplified, and a user can easily close a background program just by performing a specified operation in a response area; therefore, the operation is simple and convenient.

### CROSS REFERENCE TO RELATED APPLICATIONS

This patent application is a continuation of PCT/CN2013/086880, filed on Nov. 11, 2013 and titled “METHOD AND APPARATUS FOR CLOSING PROGRAM, AND STORAGE MEDIUM”, which claims priority to Chinese Patent Application No. 201310035963.0, filed by Tencent Technology (Shenzhen) Company Limited on Jan. 30, 2013, and titled “METHOD AND APPARATUS FOR CLOSING BACKGROUND PROGRAM”, both of which are incorporated by reference in their entirety.

### FIELD OF THE TECHNOLOGY

The present disclosure relates to the field of mobile communications and the field of program processing, and in particular, to a method and an apparatus for closing a program, and a storage medium.

### BACKGROUND OF THE DISCLOSURE

Apple iOS is a handheld device operating system developed by Apple Incorporation. Apple Incorporation initially designs the iOS system for iPhones, and later the system is gradually applied to Apple products such as iPod touch, iPad, and Apple TV. The iOS is a Unix-like commercial operating system. Currently, the iOS has occupied 30% of the global market of smartphone system.

Generally, in the Apple iOS system, a multitasking processing queue can be displayed by a double-tap on a home button of a handheld device, and background program(s) in the iOS system is(are) displayed in the multitasking processing queue. The background program refers to a program that a user does not directly operate. Excessive background programs in the system lead to excessive system memory occupation and inefficiency. Therefore, how to quickly clean up the background program and to completely close the background program becomes particularly important.

In the iOS system, a process of closing a background program is as follows: performing a double-tap on a home button of a handheld device to display a multitasking processing shaking; and then tapping a closing button at the upper left corner of the icon of the program to be closed. In this way, the user can exit the program. If the user wants to close all background programs, the user needs to tap closing buttons of icons one by one. The operation process is very troublesome and inconvenient.

### SUMMARY

In order to simplify an operation of closing a background program, the present disclosure provides a method and an apparatus for closing a program, and a storage medium.

The method for closing a program provided in the present disclosure includes:

opening, by a mobile terminal, a task management area of a multitasking processing queue, a response area being provided in the task management area;

detecting, by the mobile terminal, in the response area; and

closing, by the mobile terminal, all programs in the multitasking processing queue in response to a specified operation of a user detected in the response area.

The apparatus for closing a program provided in the present disclosure includes one or more processors; memory; and a plurality of program modules stored in the memory and to be executed by the one or more processors. The plurality of program modules may include:

an initial processing module, configured to open a task management area of a multitasking processing queue, a response area being provided in the task management area;

a detection module, configured to detect in the response area; and

a response module, configured to close all programs in the multitasking processing queue in response to a specified operation of a user detected in the response area by the detection module.

The present disclosure provides a storage medium containing computer executable instructions, when executed by a computer processor, the computer executable instructions being used for performing the method for closing a program.

### BRIEF DESCRIPTION OF THE DRAWINGS

To describe the technical solutions of embodiments of the present invention more clearly, the following briefly introduces the appending drawings required for describing the embodiments. Apparently, the appending drawings in the following description show only some embodiments of the present invention, and a person of ordinary skill in the art may still derive other drawings from these appending drawings without creative efforts.

FIG. 1 is a flowchart of a method for closing a program according to Embodiment 1 of the present invention;

FIG. 2 is a flowchart of a method for closing a program according to Embodiment 2 of the present invention;

FIGS. 3A and 3B are schematic diagrams of opening a multitasking processing queue according to Embodiment 2 of the present invention, wherein FIG. 3A shows a home screen of a device, on which various applications are displayed, and FIG. 3B shows a multitasking processing queue is opened and displayed;

FIG. 4A is a schematic diagram of a user finger sliding rightward in a response area according to Embodiment 2 of the present invention, and FIG. 4B is a view similar to FIG. 4A showing a variant of the user finger sliding rightward in the response area;

FIG. 5A is a schematic diagram of closing a background program in a form of an animation according to Embodiment 2 of the present invention, and FIG. 5B is a view similar to FIG. 5A without animation;

FIG. 6 is a structural diagram of an apparatus for closing a program according to Embodiment 3 of the present invention; and

FIG. 7 is another structural diagram of an apparatus for closing a program according to Embodiment 3 of the present invention.

### DESCRIPTION OF EMBODIMENTS

To make the objectives, technical solutions, and advantages of the present disclosure clearer, the following further describes the embodiments of the present invention in detail with reference to the appending drawings.

By using the method and the apparatus for closing a program, and the storage medium provided in the present disclosure, a task management area of a multitasking processing queue is opened; a response area in the task management area is detected; and all programs in the multitasking processing queue are closed if a specified operation of a user in the response area is detected. The operation of closing a background program is simplified, and a user can easily close a background program just by performing a specified operation in a response area; therefore, the operation is simple and convenient.

### Embodiment 1

Referring to FIG. 1, a method for closing a program is provided in this embodiment, including the following steps.

In Step 101, a task management area of a multitasking processing queue is opened, where a response area is provided in the task management area. The response area is configured to provide the user with an interface for inputting an instruction or an operation. A mobile communication terminal (or a mobile terminal), including but not limited to, iPads, iPhones, iPods, tablets, and smart phones, can perform corresponding processing according to an operation of the user in the response area.

In Step 102, detection, by the mobile terminal is performed in the response area.

In Step 103, all programs in the multitasking processing queue are closed, by the mobile terminal, in response to a specified operation of a user detected in the response area.

Exemplarily, closing all programs in the multitasking processing queue may include: closing all background programs in the multitasking processing queue.

Exemplarily, closing all background programs in the multitasking processing queue may include: closing all background programs in the multitasking processing queue except a background program in a white list, where the white list includes a background program that is specified by the user as not to be closed.

Exemplarily, the specified operation of the user detected in the response area may include:

a slide operation of the user in the response area; or

a button tap operation of the user in the response area.

Exemplarily, a slide button is provided in the response area for the user to perform a slide operation; and correspondingly, the slide operation of the user in the response area may include: the slide operation of the user on the slide button.

Exemplarily, closing all background programs in the multitasking processing queue may include: closing all the background programs in the multitasking processing queue in a form of an animation, where in the animation, icons of all the background programs in the multitasking processing queue sequentially move leftward in a right-to-left order; each icon gradually gets smaller and gradually covers an adjacent icon at left during movement; and all the icons are deleted when the rightmost icon moves to the leftmost side and all other icons are covered.

Exemplarily, opening the task management area of the multitasking processing queue may include: opening the task management area of the multitasking processing queue in response to a double-tap of the user on a main button of a screen; or opening the task management area of the multitasking processing queue in response to a specified operation of the user on a home screen.

The method provided in the foregoing embodiment may be applied to an iOS system.

In the method for closing a program provided in the foregoing embodiment, a task management area of a multitasking processing queue is opened; a response area in the task management area is detected; and all programs in the multitasking processing queue are closed if a specified operation of a user in the response area is detected. An operation of closing a background program is simplified, and a user can easily close a background program just by performing a specified operation in a response area; therefore, the operation is simple and convenient.

### Embodiment 2

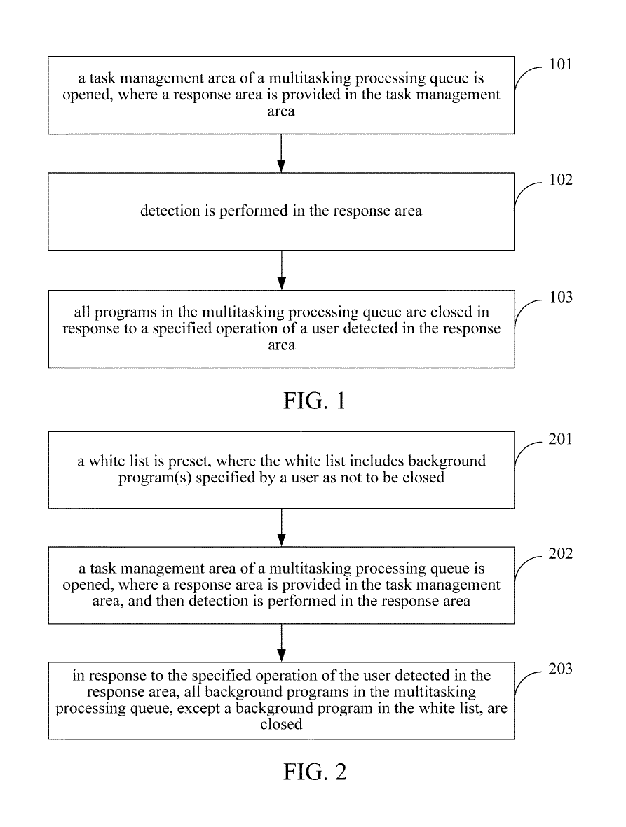

Referring to FIG. 2, a method for closing a program is provided in this embodiment, including the following steps.

In Step 201, a white list is preset by a mobile terminal, where the white list includes background program(s) specified by a user as not to be closed.

In Step 202, a task management area of a multitasking processing queue is opened by the mobile terminal, where a response area is provided in the task management area, and then detection is performed in the response area.

Opening the task management area of the multitasking processing queue includes:

opening the task management area of the multitasking processing queue in response to a double-tap of the user on a main button of a screen; or

opening the task management area of the multitasking processing queue in response to a specified operation of the user on a home screen.

In this embodiment, when the task management area of the multitasking processing queue is opened, all background programs in a system are displayed in the task management area, where each program is represented by a corresponding icon. Generally, the task management area is an area at a lower part of a screen of a device, which is not specifically limited in the present disclosure. The user may view icons of the background programs by sliding using a finger.

The double-tap on the main button of the screen refers to a double-tap on a home button. When the user performs a double-tap on the home button, the task management area of the multitasking processing queue can be triggered to be opened. In addition to this implementation manner, this embodiment further provides another manner in which an operation is pre-specified, and the task management area of the multitasking processing queue is triggered to be opened when the user performs the operation on the home screen. There may be multiple pre-specified operations, for example, a user finger sliding upward or sliding downward, which is not specifically limited in the present disclosure.

The response area refers to another area also displayed in the task management area when the icons of the background programs in the multitasking processing queue are displayed; the user performs a specified operation in the area, and a response of closing the background programs is triggered by the specified operation in the response area. In this embodiment, the response area may be in multiple forms, for example, a long and narrow rectangular area. The user finger slides rightward in the area to trigger the closing of the background programs in the multitasking processing queue.

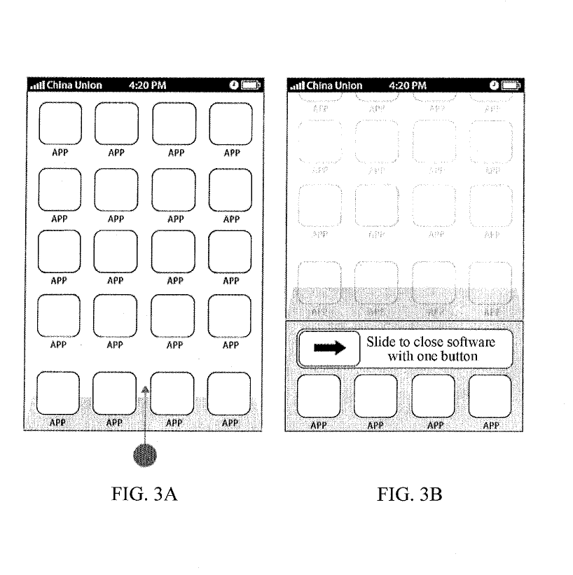

FIGS. 3A and 3B are schematic diagrams of opening a multitasking processing queue provided in this embodiment. FIG. 3A shows a home screen of a device, on which various applications (APPs) in the system are displayed. When a user finger slides upward on the screen, a multitasking processing queue is triggered to be opened, as shown in FIG. 3B. In the multitasking processing queue, icon of background programs are in the lower part, and a rectangular response area is in the upper part. When the user finger slides rightward in the response area, the background programs in the multitasking processing queue can be triggered to be closed.

In Step 203, in response to the specified operation of the user detected in the response area, all background programs in the multitasking processing queue, except a background program in the white list, are closed.

In this embodiment, the specified operation in the response area may be in multiple forms, including, but not limited to, any one of the following operations: a slide operation, a button tap operation, and the like.

Specifically, the specified operation of the user detected in the response area may include a slide operation of the user in the response area; or a button tap operation of the user in the response area.

Exemplarily, a slide button may be provided in the response area for the user to perform a slide operation; and correspondingly, the slide operation of the user in the response area may include the slide operation of the user on the slide button.

Exemplarily, closing all background programs in the multitasking processing queue except the background program in the white list may include:

closing all the background programs in the multitasking processing queue except the background program in the white list in a form of an animation, where in the animation icons of all the background programs in the multitasking processing queue sequentially move leftward in a right-to-left order; each icon gradually gets smaller and gradually covers an adjacent icon at left during movement; and all the icons are deleted when the rightmost icon moves to the leftmost side and all other icons are covered.

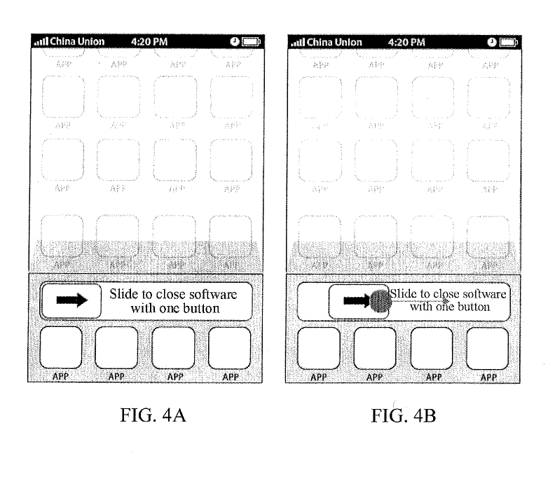

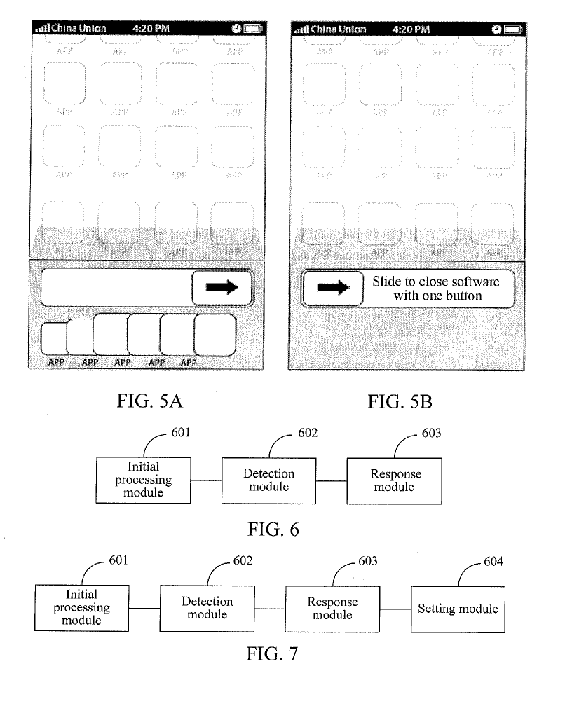

For example, FIGS. 4A and 4B are schematic diagrams of a user finger sliding rightward in a response area provided in this embodiment. Description is made by using the case of sliding rightward in rectangular response area as an example. In actual application, another operation may also be specified, which is not described in more details herein. FIG. 5A is a schematic diagram of closing a background program in a form of an animation provided in this embodiment. Both FIGS. 5A and 5B show the response area in the upper part shows a process of sliding rightward by the finger. As shown in FIG. 5A, the lower part displays that the icons of the background programs move leftward to each other and disappear one by one along with the sliding of the finger and finally all icons of the background programs disappear, which indicates that closing the background programs is finished. If a white list set by the user is stored, background program(s) in the white list is retained, and icons of the other background programs gradually move to each other till disappear.

In the method for closing a program provided in this embodiment, a task management area of a multitasking processing queue is opened; detection is performed in a response area of the task management area; and all background programs in the multitasking processing queue are closed if a specified operation of a user in the response area is detected. The operation of closing a background program is simplified, and a user can easily close a background program just by performing a specified operation in a response area; therefore, the operation is simple and convenient. Background program may be closed by one button, and a problem of background cache garbage is solved. Further, by introducing the preset white list, some programs can be locked and retained in background, thus the function of closing a background program by using one button is enhanced, and application becomes more flexible.

### Embodiment 3

Referring to FIG. 6, an apparatus for closing a program is provided in this embodiment, for implementing the method shown in FIG. 1. The apparatus includes one or more processors; memory; and a plurality of program modules stored in the memory and to be executed by the one or more processors. The plurality of program modules may include:

an initial processing module 601, configured to open a task management area of a multitasking processing queue, where a response area is provided in the task management area, and for details of the response area, reference is made to descriptions in the foregoing method embodiment;

a detection module 602, configured to perform detection in the response area in the task management area opened by the initial processing module 601; and

a response module 603, configured to close all programs in the multitasking processing queue in response to a specified operation of a user detected in the response area by the detection module 602. For example, the response module 603 may be further configured to: close all background programs in the multitasking processing queue in response to the specified operation detected in the response area by the detection module 602.

Exemplarily, referring to FIG. 7, based on the embodiment shown in FIG. 6, the apparatus for closing a program provided in this embodiment of the present invention may further include:

a setting module 604, configured to preset a white list, where the white list includes a background program that is specified by the user as not to be closed. The user may set the white list at any time by using the setting module 604.

Exemplarily, the response module 603 may be further configured to:

close all the background programs in the multitasking processing queue except the background program in the white list, where the white list may be set by using the setting module 604, or may be obtained by receiving a file sent by an external device, or may be obtained from a locally stored file.

Exemplarily, the specified operation of the user detected in the response area may include a slide operation of the user in the response area; or a button tap operation of the user in the response area.

Exemplarily, a slide button may be set in the response area for the user to perform a slide operation; and correspondingly, the slide operation of the user in the response area includes the slide operation of the user on the slide button,

Exemplarily, the response module 603 may be further configured to:

close all the background programs in the multitasking processing queue in a form of an animation, where

in the animation icons of all the background programs in the multitasking processing queue sequentially move leftward in a right-to-left order; each icon gradually gets smaller and gradually covers an adjacent icon at left during movement; and all the icons are deleted when the rightmost icon moves to the leftmost side and all other icons are covered.

Exemplarily, the initial processing module 601 may be further configured to:

open the task management area of the multitasking processing queue when a double-tap of the user on a main button of a screen is detected; or

open the task management area of the multitasking processing queue when a specified operation of the user on a home screen is detected,

The apparatus for closing a program provided in the foregoing embodiment can perform the method provided in any one of the foregoing method embodiments. For a detailed process, reference may be made to descriptions in the method embodiments, which is not described herein again. The apparatus may be applied to an iOS system, for example, applied to an operating system of a smartphone such as iPhone, or a tablet computer such as iPad, which is not specifically limited in the present disclosure.

In the apparatus for closing a program provided in the foregoing embodiment, an initial processing module opens a task management area of a multitasking processing queue; a detection module performs detection in a response area of the task management area; and the response module closes all programs in the multitasking processing queue in response to a specified operation of a user detected in the response area by the detection module. An operation of closing a background program is simplified, and a user can easily close a background program just by performing a specified operation in a response area; therefore, the operation is simple and convenient. By introducing a preset white list, some programs can be locked and retained in background, thus the function of closing a background program by using one button is enhanced, and application becomes more flexible.

This embodiment of the present invention provides a storage medium containing computer executable instructions, when executed by a computer processor, the computer executable instructions implement:

opening a task management area of a multitasking processing queue, where a response area is provided in the task management area;

detecting in the response area; and

closing all programs in the multitasking processing queue in response to a specified operation of a user detected in the response area.

Optionally, closing all programs in the multitasking processing queue includes:

closing all background programs in the multitasking processing queue.

Optionally, closing all background programs in the multitasking processing queue includes:

closing all background programs in the multitasking processing queue except a background program in a white list, where the white list includes a background program that is specified by the user as not to be closed.

Optionally, the specified operation of a user detected in the response area includes:

a slide operation of the user in the response area; or

a button tap operation of the user in the response area.

Optionally, a slide button is provided in the response area for the user to perform a slide operation; and the slide operation of the user in the response area includes the slide operation of the user on the slide button.

Optionally, closing all background programs in the multitasking processing queue includes:

closing all the background programs in the multitasking processing queue in a form of an animation, where

in the animation icons of all the background programs in the multitasking processing queue sequentially move leftward in a right-to-left order; each icon gradually gets smaller and gradually covers an adjacent icon at left during movement; and all the icons are deleted when the rightmost icon moves to the leftmost side and all other icons are covered.

Optionally, opening the task management area of the multitasking processing queue includes:

opening the task management area of the multitasking processing queue in response to a double-tap of the user on a main button of a screen; or

opening the task management area of the multitasking processing queue in response to a specified operation of the user on a home screen.

Optionally, the method is applied to an iOS system.

The sequence numbers of the above embodiments of the disclosure are only for the purpose of description, and do not represent one embodiment is superior to another.

A person of ordinary skill in the art may understand that all or some of the steps of the foregoing embodiments may be implemented by using hardware, or may be implemented by a program instructing relevant hardware. The program may be stored in a computer readable storage medium. The storage medium may be a read-only memory, a magnetic disk, an optical disc, or the like.

The foregoing descriptions are merely preferred embodiments of the present invention, but are not intended to limit the present disclosure. Any modification, equivalent replacement, or improvement made within the spirit and principle of the present disclosure shall fall within the protection scope of the present disclosure.

What is claimed is:

1. A method for closing a program, comprising:
opening, by a mobile terminal, a task management area of a multitasking processing queue, a response area being provided in the task management area;
detecting, by a mobile terminal, in the response area; and
closing, by a mobile terminal, all programs in the multitasking processing queue in response to a specified operation of a user detected in the response area.

2. The method according to claim 1, wherein closing all programs in the multitasking processing queue comprises:
closing all background programs in the multitasking processing queue.

3. The method according to claim 2, wherein closing all background programs in the multitasking processing queue comprises:
closing all background programs in the multitasking processing queue except a background program in a white list, wherein the white list comprises a background program that is specified by the user as not to be closed.

4. The method according to claim 1, wherein the specified operation of the user detected in the response area comprises:
a slide operation of the user in the response area; or
a button tap operation of the user in the response area.

5. The method according to claim 4, wherein a slide button is provided in the response area for the user to perform the slide operation; and
the slide operation of the user in the response area comprises:
the slide operation of the user on the slide button.

6. The method according to claim 2, wherein closing all background programs in the multitasking processing queue comprises:
closing all the background programs in the multitasking processing queue in a form of an animation, wherein
in the animation icons of all the background programs in the multitasking processing queue sequentially move leftward in a right-to-left order; each icon gradually gets smaller and gradually covers an adjacent icon at left during movement; and all the icons are deleted when the rightmost icon moves to the leftmost side and all other icons are covered.

7. The method according to claim 1, wherein opening the task management area of the multitasking processing queue comprises:
opening the task management area of the multitasking processing queue in response to a double-tap of the user on a main button of a screen; or
opening the task management area of the multitasking processing queue in response to a specified operation of the user on a home screen.

8. The method according to claim 1, wherein the method is applied to iOS system.

9. An apparatus for closing a program, comprising:
one or more processors;
memory; and
a plurality of program modules stored in the memory and to be executed by the one or more processors, the plurality of program modules comprising:
an initial processing module, configured to open a task management area of a multitasking processing queue, a response area being provided in the task management area;
a detection module, configured to detect in the response area; and
a response module, configured to close all programs in the multitasking processing queue in response to a specified operation of a user detected in the response area by the detection module.

10. The apparatus according to claim 9, wherein the response module closes all background programs in the multitasking processing queue in response to the specified operation detected in the response area by the detection module.

11. The apparatus according to claim 10, wherein the response module closes all background programs in the multitasking processing queue except a background program in a white list, wherein the white list comprises a background program that is specified by the user as not to be closed.

12. The apparatus according to claim 9, wherein the specified operation of the user detected in the response area comprises:
a slide operation of the user in the response area; or
a button tap operation of the user in the response area.

13. The apparatus according to claim 12, wherein a slide button is provided in the response area for the user to perform a slide operation; and
the slide operation of the user in the response area comprises the slide operation of the user on the slide button.

14. The apparatus according to claim 10, wherein the response module closes all the background programs in the multitasking processing queue in a form of an animation, wherein
in the animation icons of all the background programs in the multitasking processing queue sequentially move leftward in a right-to-left order; each icon gradually gets smaller and gradually covers an adjacent icon at left during movement; and all the icons are deleted when the rightmost icon moves to the leftmost side and all other icons are covered.

15. The apparatus according to claim 9, wherein the initial processing module opens the task management area of the multitasking processing queue in response to a double-tap of the user on a main button of a screen; or
opens the task management area of the multitasking processing queue in response to a specified operation of the user on a home screen.

16. The apparatus according to claim 9, wherein the apparatus is applied with an iOS system.

17. A storage medium containing computer executable instructions, when executed by a computer processor, the computer executable instructions being used for performing:
opening a task management area of a multitasking processing queue, a response area being provided in the task management area;
detecting in the response area; and
closing all programs in the multitasking processing queue in response to a specified operation of a user detected in the response area.
